(19) United States
(12) Patent Application Publication
(10) Pub. No.: US 2014/0067992 A1
(43) Pub. Date: Mar. 6, 2014

(54) COMPUTER PRODUCT, COMMUNICATION NODE, AND TRANSMISSION CONTROL METHOD

(71) Applicant: FUJITSU LIMITED, Kawasaki-shi (JP)

(72) Inventor: Toshiaki SAEKI, Kawasaki (JP)

(21) Appl. No.: 13/930,791

(22) Filed: Jun. 28, 2013

(30) Foreign Application Priority Data
Aug. 28, 2012 (JP) 2012-187993

(51) Int. Cl. H04L 29/08

(52) U.S. Cl. CPC H04L 29/08549
USPC 709/214

(57) ABSTRACT

A computer-readable recording medium stores a program causing a first node to execute a process including identifying among nodes in a system, a second node that has data identical to data in the first node; comparing a first effect level representing a degree to which performance of the system is affected by communication between the first node and a transmission destination node of the data, and a second effect level representing a degree to which the performance is affected by communication between the second node and the transmission destination node, by referring to a storage device that stores effect levels respectively representing a degree to which the performance of the system is affected by communication between the transmission destination node and each node among the nodes; and transmitting based on a comparison result, the data to the transmission destination node by controlling a communicating unit that communicates with the nodes.

### CROSS REFERENCE TO RELATED APPLICATIONS

This application is based upon and claims the benefit of priority of the prior Japanese Patent Application No. 2012-187993, filed on Aug. 28, 2012, the entire contents of which are incorporated herein by reference.

### FIELD

The embodiments discussed herein are related to a computer product, a communication node, and a transmission control method.

### BACKGROUND

According to a conventional technique, data is duplicated; and the duplicated data is distributed to and stored in nodes included in a network. For example, according to a technique, updatable core data and readable data duplicated therefrom are distributed in a network; and the core data is dynamically moved according to the state of use and the state of the network. According to another technique, to maintain redundancy of data in a file server, data identical to the data whose redundancy has been degraded is stored and a file server that is closest to the transmission destination node in the network is set to be a transmission source node (see, e.g., Japanese Laid-Open Patent Publication Nos. 2003-256256 and 2005-141528).

However, according to the conventional techniques, in the system, communication among the nodes is necessary when the transmission source node of the data is determined from among the group of nodes each storing therein the same data, resulting in an increase of the load on the system.

### SUMMARY

According to an aspect of an embodiment, a computer-readable recording medium stores a transmission control program that causes a first node to execute a process that includes identifying among nodes included in a system, a second node that stores therein data that is identical to data stored in the first node; comparing a first effect level representing a degree to which performance of the system is affected by communication between the first node and a transmission destination node that is a transmission destination of the data among the nodes, and a second effect level representing a degree to which the performance of the system is affected by communication between the identified second node and the transmission destination node, by referring to a storage device that stores effect levels respectively representing a degree to which the performance of the system is affected by communication between the transmission destination node and each node among the nodes; and transmitting based on a result obtained at the comparing, the data to the transmission destination node by controlling a communicating unit that communicates with the nodes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is an explanatory diagram (Part I) of an example of operation of the distributed processing system according to an embodiment;

FIG. 1B is an explanatory diagram (Part II) of the example of operation of the distributed processing system according to the embodiment;

FIG. 1C is an explanatory diagram (Part III) of the example of operation of the distributed processing system according to the embodiment;

FIG. 2 is an explanatory diagram of an example of a system configuration of the distributed processing system;

FIG. 3 is a block diagram of an example of a hardware configuration of a node according to the embodiment;

FIG. 4 is an explanatory diagram of an example of software configuration of the distributed processing system;

FIG. 5 is an explanatory diagram of an example of the storage content of an HDFS;

FIGS. 6A and 6B are explanatory diagrams of an example of a method of storing a file using the HDFS;

FIG. 7 is a block diagram of an example of a functional configuration of the node;

FIG. 8 is an explanatory diagram of an example of the storage content of a route table;

FIG. 9 is an explanatory diagram of a specific example of a MapReduce process;

FIG. 10 is an explanatory diagram of a detailed example of a map process;

FIGS. 11A and 11B are explanatory diagrams of an example of a transmission destination node for a map process result;

FIG. 12 is an explanatory diagram of an example of a first transmission method for data X′;

FIG. 13 is an explanatory diagram of an example of a second transmission method for the data X′;

FIG. 14 is an explanatory diagram of an example of the third transmission method for the data X′;

FIG. 15 is an explanatory diagram of an example of transmission determination for the data X′;

FIG. 16 is an explanatory diagram of a first specific example of a route effect level function f;

FIG. 17 is an explanatory diagram of a second specific example of the route effect level function f;

FIG. 18 is an explanatory diagram of a third specific example of the route effect level function f;

FIG. 19 is an explanatory diagram of a fourth specific example of the route effect level function f;

FIG. 20 is an explanatory diagram of a fifth specific example of the route effect level function f;

FIG. 21 is the flowchart of an example of a procedure for the MapReduce process; and

FIG. 22 is the flowchart of an example of a procedure for a transmission determination process.

### DESCRIPTION OF EMBODIMENTS

An embodiment of a transmission control program, a communication node, and a transmission control method will be described in detail with reference to the accompanying drawings. A node will be described that is included in a distributed processing system and that executes distributed processing, as an example of a communication node according to the embodiment.

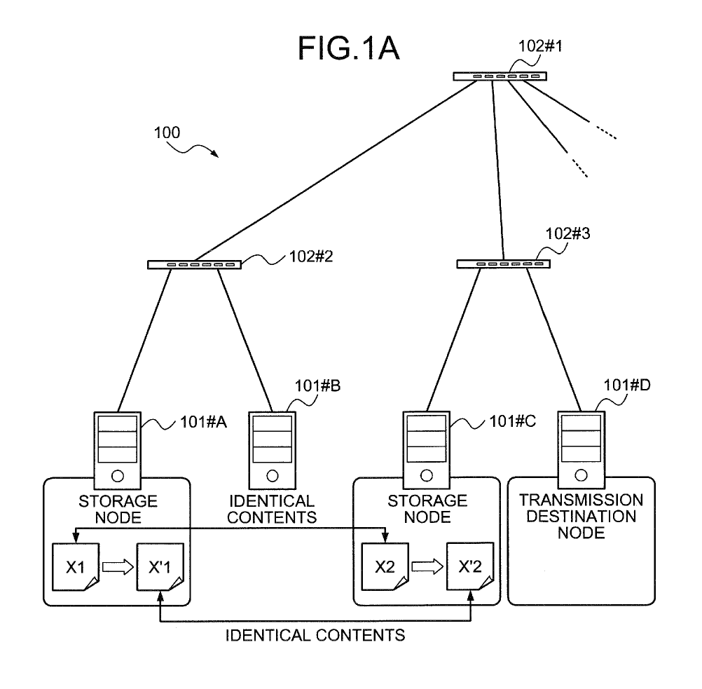

FIG. 1A is an explanatory diagram (Part I) of an example of operation of the distributed processing system according to the embodiment. FIG. 1B is an explanatory diagram (Part II) of the example of operation of the distributed processing system according to the embodiment. FIG. 1C is an explanatory diagram (Part III) of the example of operation of the distributed processing system according to the embodiment. The distributed processing system 100 according to the embodiment includes nodes 101#A to 101#D that each execute distributed processing, and switches 102#1 to 102#3. Hereinafter, the switches 102 will each be simply referred to as “switch”.

The distributed processing in the embodiment will be described using an example where the distributed processing system 100 employs “Hadoop”. “Hadoop” is software executing “MapReduce” that is a technique to distribute and process a huge amount of data. MapReduce divides data into plural data items. Each of the nodes executes a map process for the resulting data items to be processed. At least any one of the nodes executes a reduce process for the process result of the map process as data to be processed.

A map process is independent of other map processes and all the map processes can be executed in parallel to each on another. For example, the map process is a process to output data in a “KeyValue” format using a portion of the data in the distributed processing system 100, executed independently from the other map processes executed for the other portions of the data as the data to be processed. The “data in the KeyValue format” is a combination of an arbitrary value that is stored in a value field and that is desired to be preserved, and a unique indicator corresponding to the data that is stored in a key field and that is desired to be preserved.

The reduce process is a process executed for, as the data to be processed, one or more process result(s) formed by consolidating the process result(s) of the map process(es) based on the attribute of the process result of each of the map processes. For example, when the process result of the map process is data in the KeyValue format, the reduce process is a process executed for, as the data to be processed, one or more process result(s) formed by consolidating the result(s) of the map process(es) based on the key field that is the attribute of the process result of each of the map processes. For example, the reduce process may be a process executed for, as the data to be processed, one or more process result(s) formed by consolidating the result(s) of the map process(es) based on the value field.

Operations of the distributed processing system 100 according to the embodiment will be described using the terms used in Hadoop. A “job” is a process unit in Hadoop. For example, a process constitutes one job, of counting the number of times each word included in a character string appears. A “task” is a process unit formed by dividing a job. Two kinds of task are present including a “map task” that executes the map process and a “reduce task” that executes the reduce process. To facilitate the execution of the reduce process, before the reduce process is executed, a shuffle and sort process is executed, of consolidating the processing results of the map processes based on the key field.

FIG. 1A depicts a state where the map process comes to an end in the distributed processing system 100. For example, the node 101#A executes the map process for data X1 that is the data to be processed by the map process; outputs data X′1; and stores the data X′1 to a storage area of the node 101#A. The node 101#C stores therein data X2 whose content is same as that of the data X1, outputs data X′2 whose content is same as that of the data X′1, and stores the data X′2 to a storage area of the node 101#C. In FIG. 1A, the node 101#D is an apparatus that executes the shuffle and sort process, and also is a transmission destination node for the data X′1 or the data X′2.

Hereinafter, a node storing therein data to be transmitted will be referred to as “storage node”; a node transmitting data of the “storage nodes” will be referred to as “transmission source node”; and a node receiving data will be referred to as “transmission destination node”.

In the example of FIG. 1A, the nodes 101#A and 101#C are storage nodes and the node 101#D is a transmission destination node. The distributed processing system 100 according to the embodiment determines the transmission source node that suppresses the load on the distributed processing system 100 and whose communication amount in the network is small, from among the nodes 101#A and 101#C.

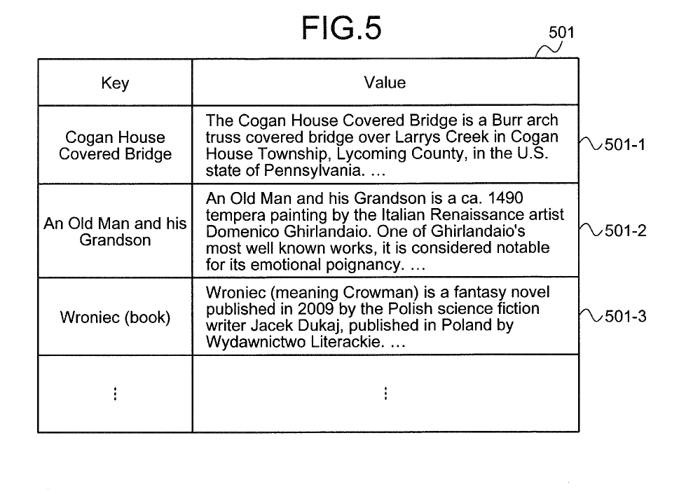

In FIG. 1A, the node 101#A to be a first node identifies the node 101#C that stores therein the data X′2 whose content is same as that of the data X′1, as another node to be a second node. Similarly, the node 101#C identifies the node 101#A that stores therein the data X′1 whose content is same as that of the data X′2, as another node. A specific method for the identification will be described later with reference to FIG. 7.

FIG. 1B is a diagram of effect levels that each indicate the degree to which the performance of the distributed processing system 100 is affected by the communication between the transmission source node and the transmission destination node when each of the storage nodes operates as the transmission source node.

Hereinafter, the degree to which the performance of the distributed processing system 100 is affected by the communication between the transmission source node and the transmission destination node may simply be described as the effect level of the communication between the nodes 101#A and 101#B. The effect level is stored in the storage area of each of the nodes 101.

It is assumed that the degree of decrease in the performance of the distributed processing system 100 is high when the value of the effect level is large, and that of the decrease in the performance is low when the value of the effect level is small. The effect level may be set such that the degree of the decrease in the performance of the distributed processing system 100 is low when the value of the effect level is large. Hereinafter, when not especially specified, it is assumed that the degree of the decrease in the performance of the distributed processing system 100 is high when the value of the effect level is large.

A function to calculate the effect level is defined as a route effect level function f (identification information of the transmission source node, identification information of the transmission destination node). The node 101#A to be the first node compares an effect level f(#A, #D) of the communication between the node 101#A and the transmission destination node with an effect level f(#C, #D) of the communication between another node and the transmission destination node. “#A” and “#D” respectively represent identification information of the nodes 101#A and 101#D, respectively. Hereinafter, the inscription “#x” will denote identification information of the #x-apparatus. Because f(#A, #D) is larger than f(#C, #D), the node 101#A is not the transmission source node and does not transmit the data X′1.

Similarly, the node 101#C compares an effect level f(#C, #D) of the communication between the node 101#C and the transmission destination node with an effect level f(#A, #D) of the communication between another node and the transmission destination node. In this case, f(#C, #D) is smaller than f(#A, #D) and, therefore, the node 101#C operates as the transmission source node and transmits the data X′2.

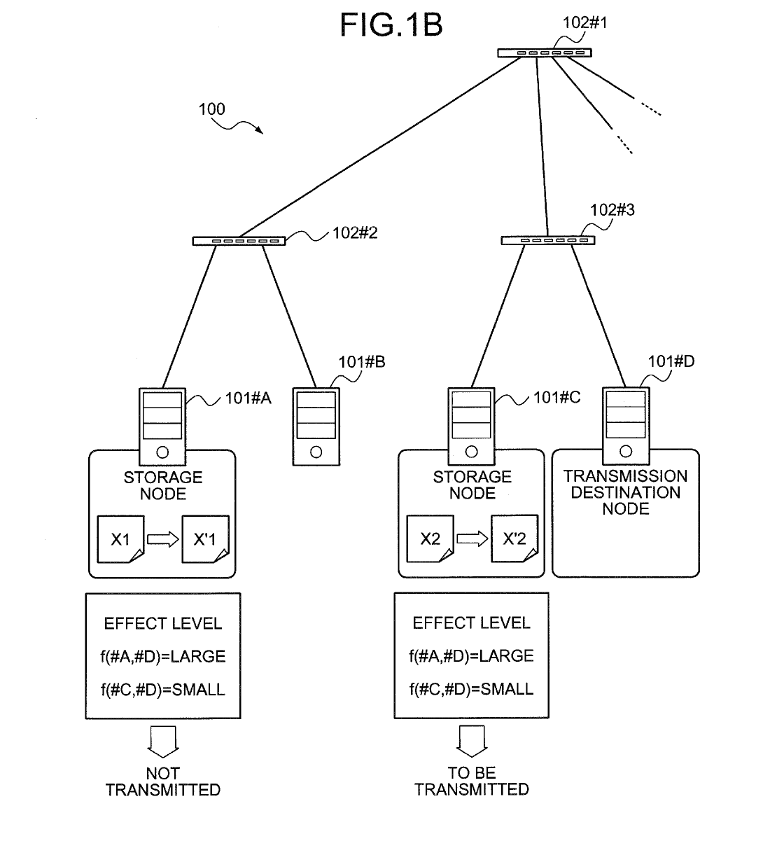

FIG. 1C depicts the state where the node 101#C transmits the data X′2 to the node 101#D. As depicted in FIG. 1C, communication is executed avoiding the switch 102#1 that tends to be a bottleneck. In this manner, each of the nodes 101 having identical data to one another determines whether the load on the communication with the transmission destination node is lower than the loads of the other nodes, based on the same criterion; and when the node 101 determines that the load is lower, the node 101 operates as the transmission source node. Thereby, the distributed processing system 100 can transfer the data through a route whose load on the distributed processing system 100 is low even when no communication is executed among the nodes. The details of the distributed processing system 100 will be described below with reference to FIGS. 2 to 22.

FIG. 2 is an explanatory diagram of an example of a system configuration of the distributed processing system. The distributed processing system 100 includes nodes 101#A to 101#H and switches 102#1 to 102#5.

The nodes 101 are each an apparatus that executes distributed processing. The nodes 101 may each be a server or a personal computer. The switches 102 are each an apparatus that relays communication. For example, the switch 102#2 relays the communication of each of the nodes 101#A and 101#B. For example, a repeater hub, a switching hub, a router, etc., can be employed for each of the switches 102. Repeater hubs, switching hubs, and routers may be employed for the switches 102 being mixed with each other. For example, the switches 102#1 and 102#5 may respectively be a router and a switching hub.

The connection relations among the nodes 101#A to 101#H and the switches 102#1 to 102#5 are as follows. The nodes 101#A and 101#B are connected to the switch 102#2. The nodes 101#C and 101#D are connected to the switch 102#3. The nodes 101#E and 101#F are connected to the switch 102#4. The nodes 101#G and 101#H are connected to the switch 102#5. The switches 102#2 to 102#5 are connected to the switch 102#1.

In this manner, the form of connection in the distributed processing system 100 is a tree type and the switch 102#1 is located upstream of the switches 102#2 to 102#5. Therefore, in the embodiment, the switch 102#1 is classified as an “upstream switch” and the switches 102#2 to 102#5 are each classified as a “downstream switch”. The upstream switch relays the communication of each of the downstream switches and, therefore, communication tends to concentrate at the upstream switch and consequently, the upstream switch tends to be a bottleneck.

The form of connection in the distributed processing system 100 may be a star type, a ring type, a mesh type, etc., or may also be a combination of the tree type, the star type, the ring type, and/or the mesh type. For example, the switch 102#1 may be connected to an external network and may be connected through the external network to a personal computer operated by a manager who manages the distributed processing system 100.

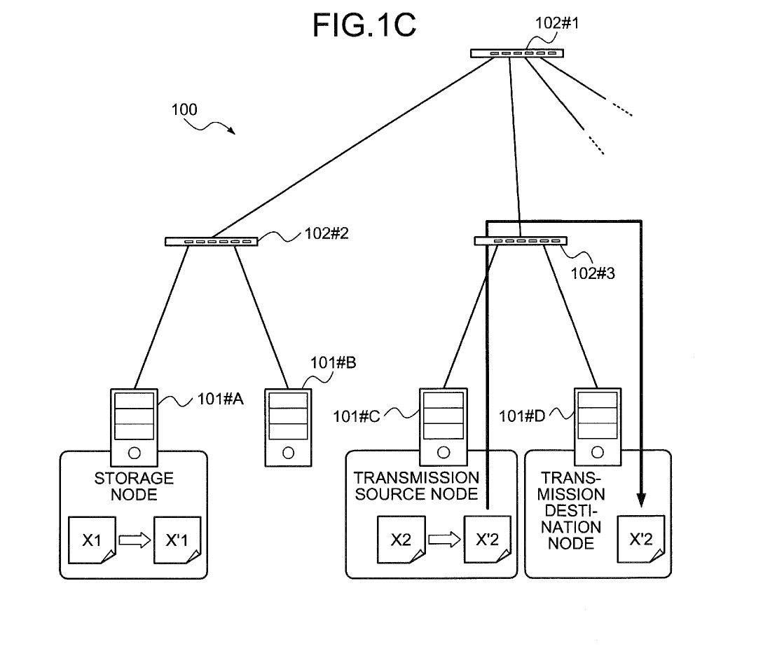

FIG. 3 is a block diagram of an example of a hardware configuration of a node according to the embodiment. As depicted in FIG. 3, the node 101 includes a central processing unit (CPU) 301, a read-only memory (ROM) 302, a random access memory (RAM) 303, a disk drive 304, a disk 305, and an interface (I/F) 306, respectively connected by a bus 307. Although not depicted in FIG. 3, the switch 102 has an identical hardware configuration.

The CPU 301 governs overall control of the node 101. The ROM 302 stores therein programs such as a boot program. The RAM 303 is used as a work area of the CPU 301.

The disk drive 304, under the control of the CPU 301, controls the reading and writing of data with respect to the disk 305. The disk 305 stores therein data written under control of the disk drive 304. As the disk drive 304, for example, a magnetic disk drive, a solid state drive, etc. can be employed. The disk 305 is non-volatile memory storing data written thereto under the control of the disk drive 304. For example, if the disk drive 304 is a magnetic disk drive, a magnetic disk can be employed as the disk 305. Further, if the disk drive 304 is a solid state drive, semiconductor memory can be employed as the disk 305.

The communication I/F 306 administers an internal interface with the network 308 and controls the input/output of data with respect to the switch 102. For example, the communication I/F 306 is connected to a network 308 such as a local area network (LAN), a wide area network (WAN), and the Internet through a communication line and is connected to other apparatuses through the network 308. For example, a modem or a LAN adaptor may be employed as the communication I/F 306. Further, the node 101 may include an optical disk drive, an optical disk, a keyboard, and a mouse.

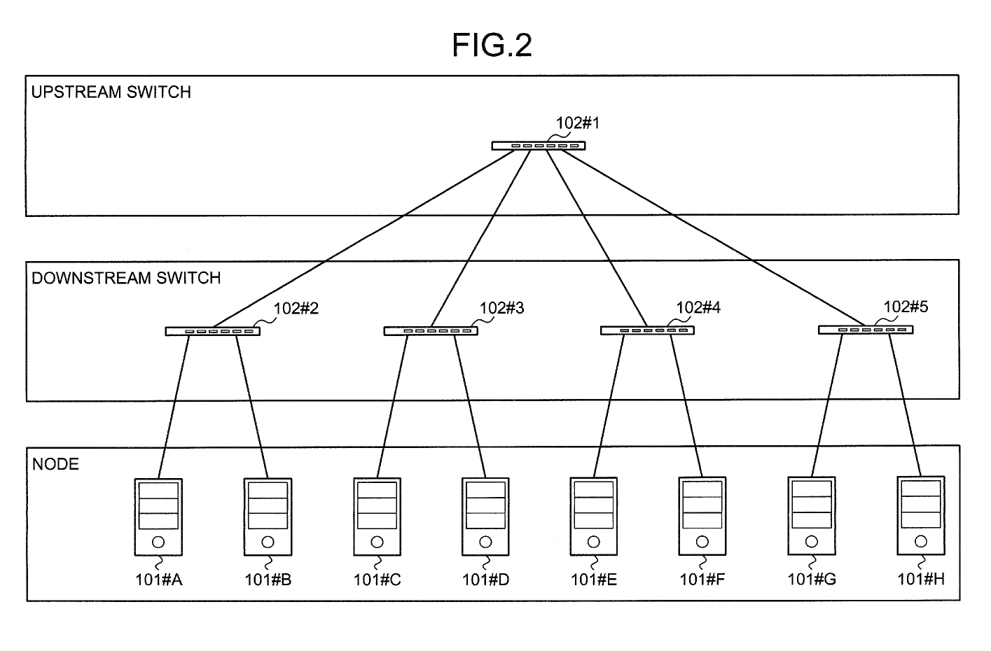

FIG. 4 is an explanatory diagram of an example of software configuration of the distributed processing system. The distributed processing system 100 includes a master node 401, slave nodes 402#1 to 402#N, a Hadoop distributed file system (HDFS) client 403, and a job client 404. “N” is a number acquired by subtracting one from the total number of the nodes 101.

The master node 401 is any one node 101 among the nodes 101#A to 101#H depicted in FIGS. 1 to 3. The slave nodes 402#1 to 402#N are nodes 101 other than the node 101 that is selected as the master node 401, among the nodes 101#A to 101#H. The HDFS client 403 and the job client 404 may each be any one node 101 among the nodes 101#A to 101#H; may each be a personal computer that is externally connected to the switch 102#1; or may be a singular apparatus. A cluster including the master node 401 and the slave nodes 402#1 to 402#N is defined as a Hadoop cluster 405. The Hadoop cluster 405 may include the HDFS client 403 and the job client 404.

The master node 401 is an apparatus that assigns the map processes and the reduce processes to the slave nodes 402#1 to 402#N. The slave nodes 402#1 to 402#N are each an apparatus that executes the map process and the reduce process assigned thereto.

The HDFS client 403 is a terminal that executes a file operation of the HDFS that is a file system unique to Hadoop. The job client 404 stores therein data to be processed in the map process, a MapReduce program to be an executable file, and a setting file of the execution file; and is also an apparatus that notifies the master node 401 of an execution request for a job.

The master node 401 includes a job tracker 411, a name node 412, an HDFS 413, and a metadata table 414. The slave node 402#x includes a task tracker 421#x, a data node 422#x, an HDFS 423#x, a map task 424#x, and a reduce task 425#x. “x” represents an integer from one to N. The HDFS client 403 includes an HDFS client application 431, and an HDFS application programming interface (API) 432. The job client 404 includes a MapReduce program 441 and a JobConf 442.

When the job tracker 411 receives a job to be executed from the job client 404, the job tracker 411 divides the job into the map task 424 and the reduce task 425, and assigns the map task 424 and the reduce task 425 to the available tracker 421 in the Hadoop cluster 405.

The name node 412 controls the storage destination of each of the files in the Hadoop cluster 405. For example, the name node 412 determines which one of the HDFSs 413 and 423#1 to 423#N is supposed to store the data to be processed in the map process, and transmits the file to the determined HDFS.

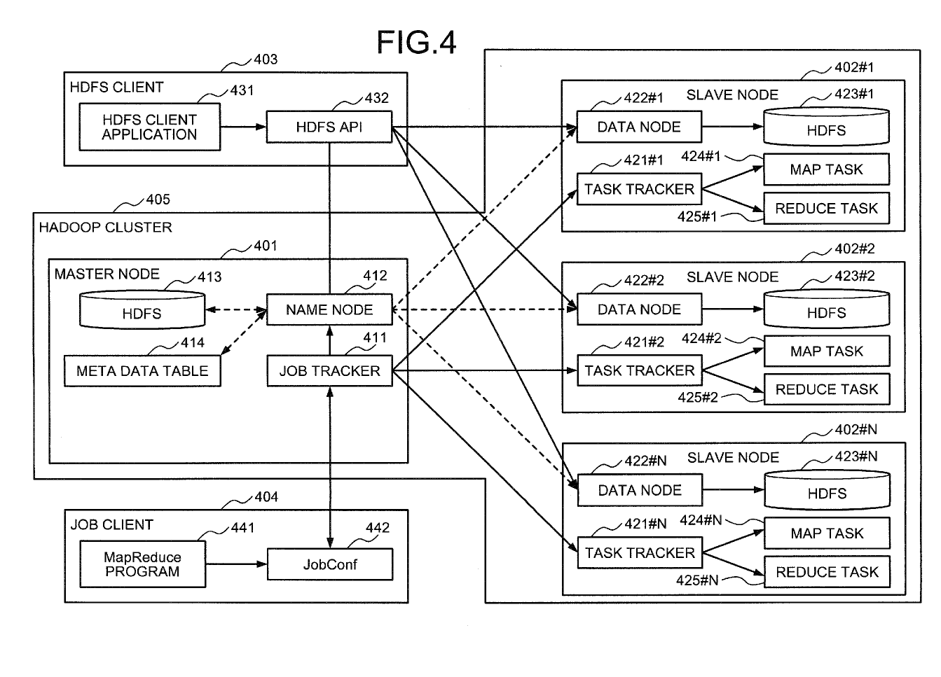

The HDFSs 413 and 423#1 to 423#N are each a storage area that divides a file and that stores the divided file. The meta data table 414 is a storage area that stores therein the locations of the files stored in the HDFSs 413 and 423#1 to 423#N. A specific method of storing the file using the meta data table 414 will be described later with reference to FIG. 6.

The task tracker 421 causes the slave node 402 to execute the map task 424 and the reduce task 425 that are assigned thereto from the job tracker 411. The task tracker 421 notifies the job tracker 411 of reports on the state of advance of each of the map task 424 and the reduce task 425 and on the completion of each processing.

The data node 422 controls the HDFS 423 in the slave node 402. The map task 424 executes the map process. The process result of the map process is stored in the storage area of the node 101 that executes the map task 424. The reduce task 425 executes the reduce process, and executes the shuffle and sort process as a pre-stage for executing the reduce process. In the shuffle and sort process, a process is executed to consolidate the results of the map processes. For example, in the shuffle and sort process, the results of the map processes are rearranged for each “key” and values for the same key are collectively output to the reduce process.

The HDFS client application 431 is an application that operates the HDFS. The HDFS API 432 is an API that accesses the HDFS and, for example, inquires whether the data node 422 retains any file, from the data node 422 when the HDFS API 432 receives an access request for the file from the HDFS client application 431.

The MapReduce program 441 includes a program to execute the map process and a program to execute the reduce program. The JobConf 442 is a program that has the settings of the MapReduce program 441 described therein. An example of the settings can be the number of produced map tasks 424, the number of produced reduce tasks 425, and the output destination of the process result of the MapReduce process.

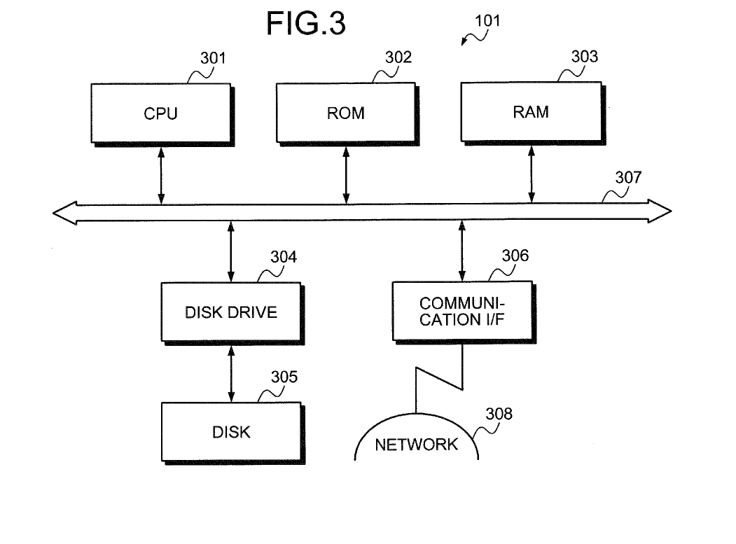

FIG. 5 is an explanatory diagram of an example of the storage content of the HDFS. A table 501 is an example of the storage content of the HDFS, and has records 501-1 to 501-3, a key field, and a value field. For example, FIG. 5 depicts a state where the record 501-1 has “Cogan House . . . ” stored in the key field and has “The Cogan House . . . ” in the value field.

FIGS. 6A and 6B are explanatory diagrams of an example of a method of storing a file using the HDFS. FIG. 6A depicts an example of the storage content of the meta data table 414. FIG. 6B depicts an example of the storage content of the HDFSs 413 and 423 according to the storage content of the meta data table 414.

The meta data table 414 depicted in FIG. 6A stores records 601-1 to 601-3 and includes two fields for “data IDentity (ID)” and “node”. The data ID field stores information that uniquely identifies data. The node field stores the ID of the node 101 storing therein the data. It is assumed that the node field depicted in FIG. 6 stores an index of the node 101.

For example, the record 601-1 indicates that the data represented by the record 501-1 is stored in the nodes 101#A, 101#C, and 101#G. In this manner, the HDFS duplicates the data and stores the duplicated data to the HDFSs 413 and 423. Preferably, the node to be the storage destination of the duplicated data is a node at a position physically distant or a node at a position distant in the network. The node at a position physically distant is, for example, a node in another rack. The node at a position distant in the network is, for example, a node whose communication is relayed by many switches when the communication is executed.

A functional configuration of the node 101 will be described. FIG. 7 is a block diagram of an example of a functional configuration of the node. The node 101 includes a receiving unit 701, an identifying unit 702, a calculating unit 703, a comparing unit 704, a transmission control unit 705, and a communicating unit 706. Functions of the units from the receiving unit 701 to the transmission control unit 705 that operate as a control unit are implemented by executing on the CPU 301, programs stored in a storage device. The storage device is, for example, the ROM 302, the RAM 303, or the disk 305 depicted in FIG. 3. Functions of the units from the receiving unit 701 to the transmission control unit 705 may be implemented by an execution of the programs by another CPU through the communication interface 306. The communicating unit 706 may be the communication interface 306 or may include a device driver that controls the operations of the communication interface 306. The device driver is stored in the storage device and controls the operations of the communication interface 306 by being executed on the CPU 301.

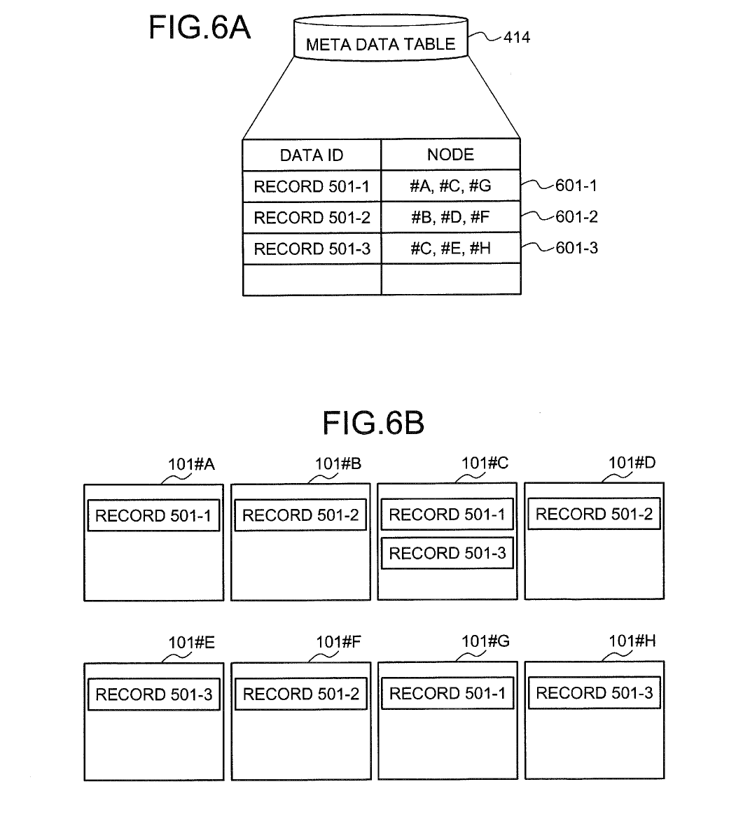

The node 101 can access a route table 711 that stores for each of the nodes, effect levels representing the degree of the effect on the performance of the distributed processing system 100 caused by the communication between the transmission destination node for the data of the plural nodes and each of the plural nodes. The transmission destination node may be fixed or may be determined based on the data. The route table 711 may store the effect level of the communication of each of the nodes with other nodes. The route table 711 is stored in the storage device such as the RAM 303 or the disk 305, and is retained by each of the nodes 101. The details of the storage content of the route table 711 will be described later with reference to FIG. 8.

The receiving unit 701 receives a transmission request. For example, the receiving unit 701 receives the process result of the map process from the map task 424 as data. It is assumed as a more specific example that the node is the node 101#A and the node 101#A executes the map task 424. In this case, the node 101#A stores the process result of the map process executed by the map task 424 in the storage area of the node 101#A. The receiving unit 701 of the node 101#A regularly refers to the storage area of the node 101#A and, thereby, detects that the process result of the map process is written into the storage area of the node 101#A. The received data is stored to the storage area such as the RAM 303 or the disk 305.

The identifying unit 702 identifies another node that stores therein data whose content is same as that of the data stored by the node 101#A, among the nodes 101 included in the distributed processing system 100. For example, when the node is the node 101#A and the record to be the data is the record 501-1, the identifying unit 702 identifies the nodes 101#C and 101#G that each store therein data whose content is same as that of the data stored in the node 101#A. For example, the identifying unit 702 may inquire the presence of the node 101 that has the data whose content is same from the master node 401 as a specific method for the identification.

The identifying unit 702 may identify other nodes from among the plural nodes 101 based on the data. For example, the identifying unit 702 may calculate the hash of the data and may identify as the other node, the node 101 whose identification information corresponds to the remainder acquired by dividing the hash by a predetermined value. The identifying unit 702 may input the data into a function g( ) that executes consistent hashing and may identify as another node, the node 101 that corresponds to the acquired result. The identification information of the identified other node is stored to the storage area such as the RAM 303 or the disk 305.

The calculating unit 703 calculates the effect level that represents the degree to which the performance of the distributed processing system 100 is affected by the communication between the node and the transmission destination node, based on the number of switches 102 that each relay the communication between the node and the transmission destination node. The calculating unit 703 also calculates the effect level that represents the degree to which the performance of the distributed processing system 100 is affected by the communication between another node and the transmission destination node, based on the number of switches 102 that each relay the communication between the other node and the transmission destination node.

For example, it is assumed that the node is the node 101#A and the transmission destination node is the node 101#C. In this case, the relaying switches 102 are the switches 102#2, 102#1, and 102#3, and therefore, the calculating unit 703 calculates the effect level of the communication between the nodes 101#A and 101#C to be 1+1+1=3. The calculating unit 703 may store indication that the switch 102#1 is the upstream switch and may handle the upstream switch as several ordinary switches 102.

The calculating unit 703 may calculate as the effect level, the total number of links of the nodes 101 and the switches 102 for the communication between the node and the transmission destination node. The number of links of the nodes 101 and the switches 102 is a value larger by one than the number of switches 102 that relay the communication between the node and the transmission destination node. For example, the sum of the links between the nodes 101#A and 101#C is four. The four links are the link between the node 101#A and the switch 102#2; the link between the switches 102#2 and 102#1; the link between the switches 102#1 and 102#3; and the link between the switch 102#3 and the node 101#C.

The calculating unit 703 may calculate each of the links that each includes an upstream switch, giving a weight thereto. For example, the calculating unit 703 may calculate the effect level, handling the link between the switches 102#2 and 102#1 and the link between the switches 102#1 and 102#3, as two links.

The calculating unit 703 calculates the effect level that represents the degree to which the performance of the distributed processing system 100 is affected by the communication between the node and the transmission destination node based on the bandwidth of the communication between the node and the transmission destination node. The calculating unit 703 may also calculate the effect level that represents the degree to which the performance of the distributed processing system 100 is affected by the communication between another node and the transmission destination node based on the bandwidth of the communication between the other node and the transmission destination node. The “bandwidth” is the range of the frequency used for the communication. A wider bandwidth causes the communication speed to be higher.

For example, the calculating unit 703 may calculate the lowest value of the bandwidths of the communication between the node and the transmission destination node, as the effect level. A bandwidth of a larger value causes the performance to be better and, therefore, when the effect level is high, the degree of the degradation of the performance of the distributed processing system 100 is high. Therefore, for example, the calculating unit 703 may calculate the inverse of the lowest value of the bandwidths for the communication between the node and the transmission destination node, as the effect level. The calculating unit 703 may also calculate a time period for predetermined data to arrive acquired by dividing the predetermined data by the bandwidth, as the effect level.

The calculating unit 703 calculates the effect level that represents the degree to which the performance of the distributed processing system 100 is affected by the communication between the node and the transmission destination node, based on the use rate of the processor or the memory of the node. The calculating unit 703 may calculate the effect level that represents the degree to which the performance of the distributed processing system 100 is affected by the communication between another node and the transmission destination node, based on the use rate of the processor or the memory of the other node.

The processor is, for example, a CPU or a digital signal processor (DSP). For the use rate of the processor, the node 101 calculates the rate of the execution time period per unit time of the CPU as the amount of the load. The node 101 may calculate the use rate based on the number of processes assigned to the CPU as another method of calculating the use rate. The node 101 may calculate the total of the processing amounts included in the processing amount information attached to the processes assigned to the CPU, as the amount of the load of the CPU. The processing amount information is acquired by measuring in advance the processing amount necessary for the corresponding process.

The use rate of the memory is the rate of the storage capacity already allocated to the software of the storage capacity of the memory to be the main storage device. The memory to be the main storage device is, for example, the RAM 303 in the hardware of the node 101.

For example, the calculating unit 703 calculates the use rate of the CPU 301 of the node as the effect level for the node and the transmission destination node. The calculating unit 703 may calculate the use rate of the RAM 303 of the node as the effect level for the node and the transmission destination node.

The calculating unit 703 may calculate the effect level by combining the number of switches 102 that relay the communication between the node and the transmission destination node, the bandwidth for the communication therebetween, and the use rate of the processor or the memory of the node. For example, the calculating unit 703 may also calculate the sum or the product of the number of switches 102 and the use rate of the CPU 301 of the node, as the effect level. The calculated effect level is stored in, for example, the route table 711.

The comparing unit 704 refers to the route table 711 and compares the effect level of the communication between the node and the transmission destination node to be the transmission destination for the data of the plural nodes 101, and the effect level for the communication between the other node identified by the identifying unit 702 and the transmission destination node.

For example, it is assumed that the effect level is three for the communication between the node 101#A storing therein the data X′1 and the node 101#D to be the transmission destination node and the effect level is one for the communication between the node 101#C storing therein the data X′2 whose content is same as that of the data X′1 and the node 101#D. In this case, the comparing unit 704 compares (the effect level for the communication between the nodes 101#A and 101#D)=3 and (the effect level for the communication between the nodes 101#C and 101#D)=1. In this case, the comparing unit 704 outputs a comparison result indicating that the degree of degradation in the performance of the distributed processing system 100 is smaller for the communication between the nodes 101#C and 101#D than for the communication between the nodes 101#A and 101#D.

The route table 711 may be configured to not store either one of the effect level for the communication between the node and the transmission destination node and the effect level for the communication between the other node and the transmission destination node. In this case, the comparing unit 704 may output a comparison result indicating that no comparison can be executed. The comparing unit 704 may execute the comparison using the effect levels that are calculated by the calculating unit 703 when the route table 711 does not store either one of the effect level for the communication between the node and the transmission destination node and the effect level for the communication between the other node and the transmission destination node.

The comparing unit 704 may also compare the effect level for the communication between the node and the transmission destination node calculated by the calculating unit 703, and the effect level for the communication between the other node and the transmission destination node calculated thereby.

When the following condition is satisfied, the comparing unit 704 may compare the lowest effect level of the effect levels for the communication between each of the plural other nodes and the transmission destination node and the effect level for the communication between the node and the transmission destination node. The condition is a case where the identifying unit 702 identifies the other nodes. For example, it is assumed that the nodes are present that include the node 101#C storing therein the data X′2 whose content is same as that of the data X′1 stored in the node 101#A to be the node; and the node 101#G storing therein data X′3 whose content is same as that of the data X′1 stored in the node 101#A. In this case, the comparing unit 704 compares the lowest effect level of the effect level for the communication between the nodes 101#C and 101#D and the effect level for the communication between the nodes 101#G and 101#D, and the effect level for the communication between the nodes 101#A and 101#D. The comparison result is stored to the storage area such as the RAM 303 or the disk 305.

The transmission control unit 705 transmits the data to the transmission destination node by controlling the communicating unit 706 based on the comparison result acquired by the comparing unit 704. When the effect level for the communication between the node and the transmission destination node is lower than the effect level for the communication between the other node and the transmission destination node, the transmission control unit 705 transmits the data to the transmission destination node by controlling the communicating unit 706. The transmission control unit 705 does not transmit any data when the effect level for the communication between the node and the transmission destination node is higher than the effect level for the communication between the other node and the transmission destination node.

When the comparing unit 704 outputs the comparison result that no comparison can be executed, the transmission control unit 705 may transmit the data to the transmission destination node. When the higher one of two effect levels can not be determined as above, it is unknown whether the other node transmits the data, and therefore, the distributed processing system 100 can prevent a case where the data is not transmitted from any node to the transmission destination node, by causing the node to transmit the data.

The transmission control unit 705 may transmit the data to the transmission destination node based on the information commonly retained by the nodes 101. For example, it is assumed that the comparing unit 704 outputs the comparison result that the effect level for the communication between the node and the transmission destination node is same as the effect level for the communication between the other node and the transmission destination node. In this case, when the number to identify the node is smaller than the number to identify the other node, the transmission control unit 705 may transmit the data. The “number to identify the node 101” is, for example, a media access control (MAC) address or an Internet protocol (IP) address.

The communicating unit 706 communicates with the nodes 101. The communication with the nodes 101 includes communication with the node 101 of the communication unit 706 The route table 711 storing the effect levels will be described with reference to FIG. 8.

FIG. 8 is an explanatory diagram of an example of the storage content of the route table. The route table 711 is a table that stores for each of the nodes 101, the effect level for the communication with the transmission destination node when the node 101 is the transmission destination node. For example, the route table 711 depicted in FIG. 8 stores records 801-A to 801-H. The route table 711 has a field for each transmission destination node, and when the effect level depends on the storage node and does not depend on the transmission destination node, may have one field.

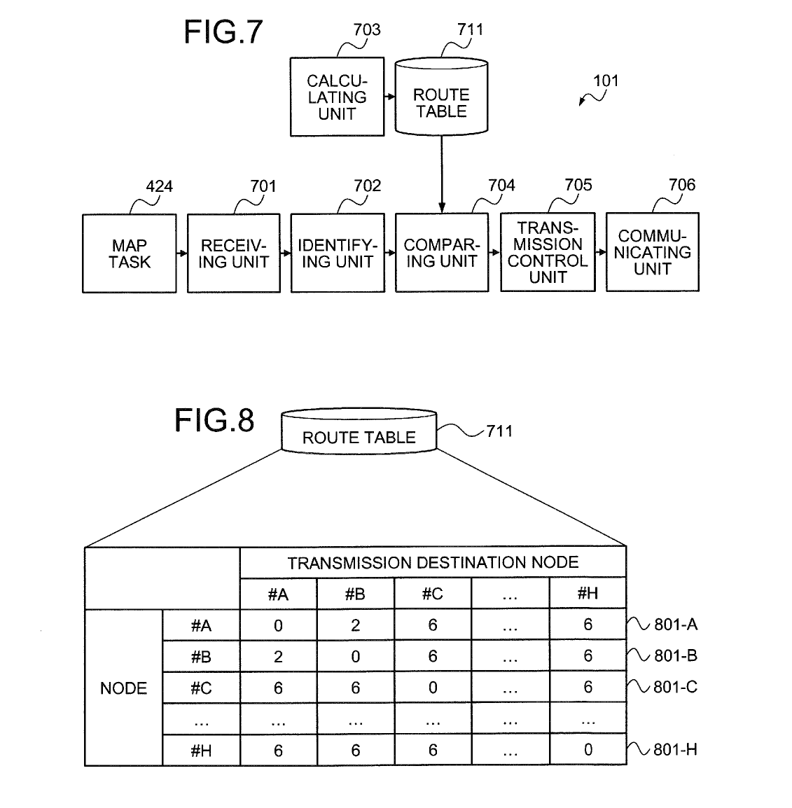

For example, when the transmission source node is the node 101#A, the record 801-A represents the effect level for each transmission destination node. For example, the record 801-A represents that the effect level is zero when the transmission destination node is the node 101#A, that the effect level is two when the transmission destination node is the node 101#B, and that the effect level is six when the transmission destination node is the node 101#C. A specific example of the MapReduce process will be described with reference to FIG. 9.

FIG. 9 is an explanatory diagram of a specific example of the MapReduce process. It is assumed for FIG. 9 that the map process is a process of counting the number of times of that each word appears in the value field for each of the records 501, and the reduce process is a process of totaling the number of appearances of each word. It is assumed for FIG. 9 that the nodes executing the map process and the reduce process are the nodes 101#A, 101#B, 101#C, etc.

The node 101#A is set to execute the map process for the record 501-1 because the node 101#A stores therein the record 501-1 and therefore, does not have to move the record 501-1 to any other one of the nodes 101. The nodes 101#C and 101#G each storing therein the record 501-1 may each execute the map process for the record 501-1. Each of the nodes 101#A, 101#C, and 101#G may execute the map process for the record 501-1. The node 101#B is set to execute the map process for the record 501-2 and the node 101#C is set to execute the map process for the record 501-3 for the same reason described above.

The nodes 101#A, 101#B, etc., each execute the map process. For example, the node 101#A executes the map process for the record 501-1 and outputs in the KeyValue format the words “The”, “Cogan”, etc., that appear in the value field of the record 501-1, and the number of times that each of the words appears. For example, the node 101#A executes the map process and outputs (The, 201), (Cogan, 42), etc., as the result of the map process.

After executing the map process, the node 101#A transmits the result of the map process to the node 101 that executes the shuffle and sort process. For example, the node 101#A transmits (The, 201) to the node 101#A and (Cogan, 42) to the node 101#B. The data that is to be transmitted to a given node can be identified based on the data using, for example, a consistent hashing method. The consistent hashing is an algorithm that is used to minimize the change of the storage destination of the data even when the number of nodes is increased or decreased.

Similarly, the node 101#B executes the map process for the record 501-2 and outputs in the KeyValue format the words “The”, “An”, etc., that appear in the value field of the record 501-2 and the number of times of appearance of each of the words. For example, the node 101#B executes the map process and outputs (The, 109), (An, 10), etc.

After the map processes executed by the nodes 101#A, 101#B, etc., come to an end, the nodes 101#A, 101#B, etc., each execute the shuffle and sort process and the reduce process. For example, the node 101#A executes the shuffle and sort process for (The, 201), (The, 109), etc., that are the result of the map process; outputs (The, (201, 109, etc.)); executes the reduce process for (The, (201, 109, etc.)) that is the result of the shuffle and sort process; and outputs (The, 1021).

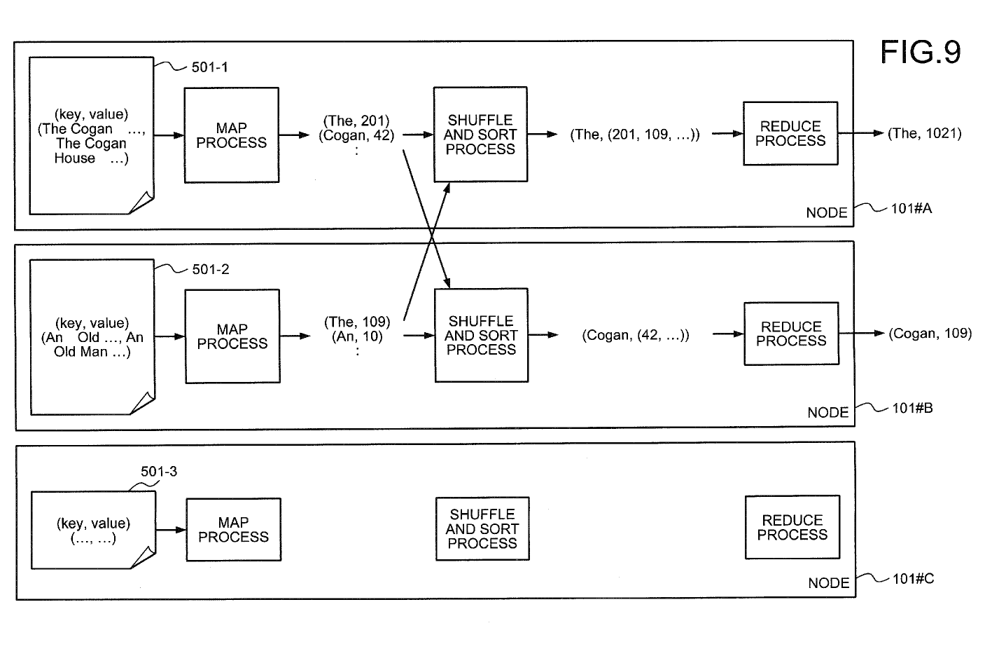

FIG. 10 is an explanatory diagram of a detailed example of the map process. Although description has been given with reference to FIG. 9 where all of the nodes 101#A, 101#C, and 101#G may execute the map process for the record 501-1, FIG. 10 depicts an example where all of the nodes 101#A, 101#C, and 101#G execute the map process for the record 501-1. In the description with reference to FIG. 10 and thereafter, the record 501-1 will be referred to as “data X” and replicas formed by duplicating the data X will be referred to as “data X1”, “data X2”, etc. For example, the node 101#A stores therein the data X1; the node 101#C stores therein the data X2; and the node 101#G stores therein the data X3.

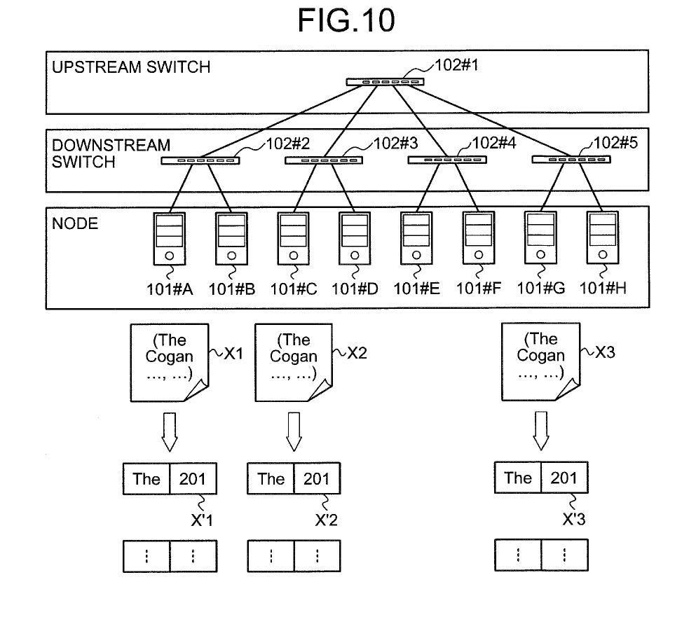

The node 101#A, which stores therein the data X1, executes the map process and outputs (The, 201), etc. In the description with reference to FIG. 10 and thereafter, (The, 201) to be the map process result for the data X will be referred to as “data X′” and replicas formed by duplicating the data X′ will be referred to as “data X′1”, “data X′2”, etc. For example, the node 101#A stores therein the data X′1; the node 101#C stores therein the data X′2; and the node 101#G stores therein the data X′3. The transmission destination node for the data X′ will be described with reference to FIGS. 11A and 11B.

FIGS. 11A and 11B are explanatory diagrams of an example of the transmission destination node for the map process result. FIGS. 11A and 11B depict the result of transmission of the result of the map process to the node 101 that executes the shuffle and sort process. For example, FIG. 11A depicts a state after the execution of the map process for the record 501-1 comes to an end and FIG. 11B depicts a state after the transmission of the result of the map process executed for the record 501-1 comes to an end.

In FIG. 11A, the nodes 101#A, 101#C, and 101#G respectively store therein data X′1, X′2, and X′3. In the description with reference to FIGS. 11A and 11B and thereafter, a node that produces the data X′ from the data X and stores therein the data X′ will be referred to as “storage node S”; a node that stores therein the data X′1 will be referred to as “storage node S1”; a node that stores therein the data X′2 will be referred to as “storage node S2”; etc. For example, the nodes 101#A, 101#C, and 101#G respectively are the storage nodes S1, S2, and S3. Any one of the storage nodes is the transmission destination node. For example, in the state depicted in FIG. 11A and thereafter, any one of the storage nodes S1 to S3 becomes the transmission source node and the transmission source node transmits the data X′ to the transmission destination node that executes the shuffle and sort process for the data X′.

FIG. 11B depicts the result of the transmission of the data X′ by any one of the storage nodes S1 to S3. The node 101 to be the transmission destination node for the data X′ will be referred to as “transmission destination node D”. A first transmission destination node for the data X′ will be referred to as “transmission destination node D1”; a second transmission destination node for the data X′ will be referred to as “transmission destination node D2”; etc. For example, the node 101#B is the transmission destination node D1; the node 101#E is the transmission destination node D2; and the node 101#G is the transmission destination node D3. The number of transmission destination nodes for the data X′ may be equal to the number of storage nodes or may be different therefrom.

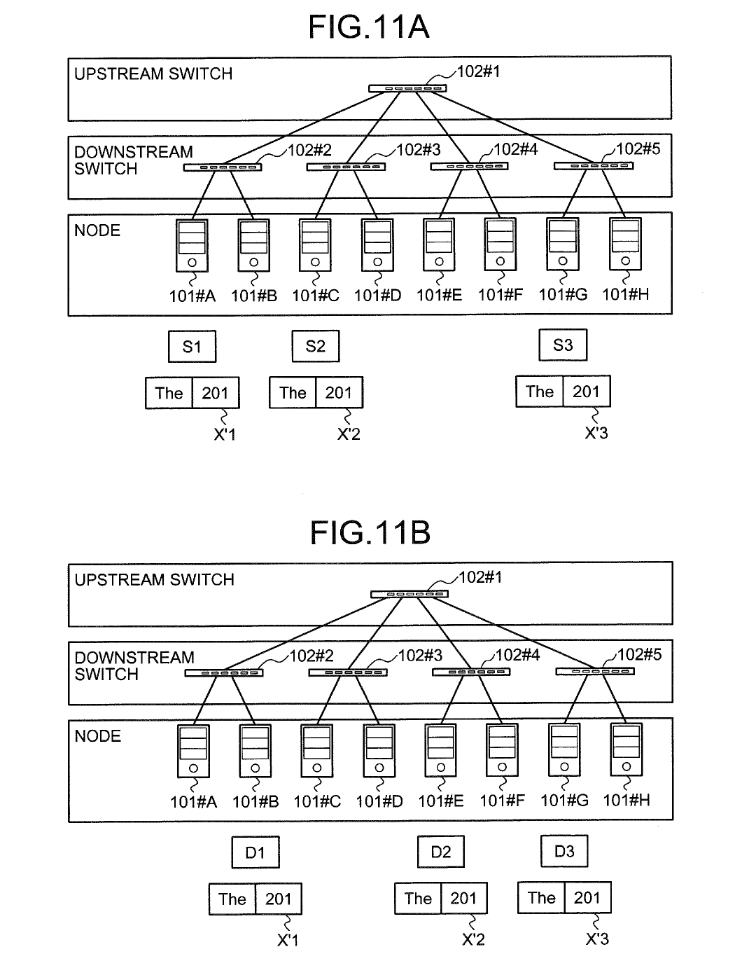

Three transmission methods will be described with reference to FIGS. 12 to 14 for the transmission method by which node 101 of the storage nodes S1 to S3 to transmit the data X′ to the transmission destination nodes D1 to D3. The three transmission methods depicted in FIGS. 12 to 14 suppress any increase of the communication amount among the nodes 101 and therefore, enable the transmission of the data X′ to the transmission destination nodes D1 to D3 even when the storage nodes S1 to S3 do not communicate with each other.

FIG. 12 is an explanatory diagram of an example of the first transmission method for the data X′. The first transmission method depicted in FIG. 12 is a method for each of the storage nodes S to transmit the data X′ stored therein to the corresponding transmission destination node D. For example, the storage node S1 transmits the data X′1 to the transmission destination node D1; the storage node S2 transmits the data X′2 to the transmission destination node D2; and the storage node S3 transmits the data X′3 to the transmission destination node D3. The first transmission method depicted in FIG. 12 is effective when the data X′1 can be recognized as the first duplicated data; the data X′2 can be recognized as the second duplicated data; and the data X′3 can be recognized as the third duplicated data.

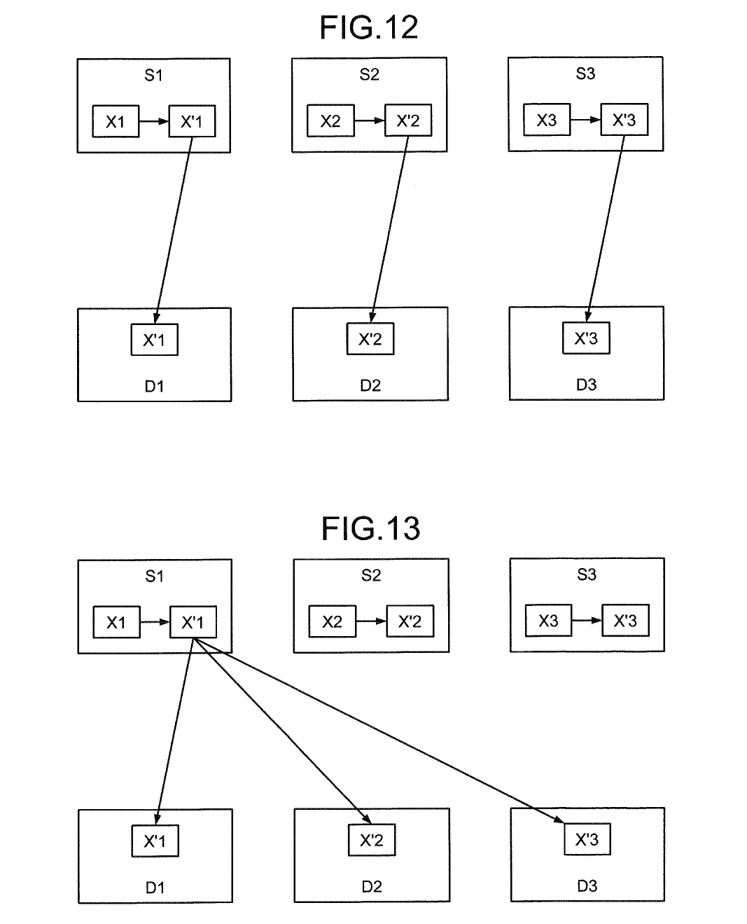

FIG. 13 is an explanatory diagram of an example of the second transmission method for the data X′. The second transmission method depicted in FIG. 13 is a method for any one of the storage nodes S to transmit the data X′ to all of the transmission destination nodes D. For example, the storage node S1 transmits the data X′1 to the transmission destination nodes D1 to D3. The transmission destination node D2 receives the data X′1 and stores therein the data X′1 as the data X′2. Similarly, the transmission destination node D3 receives the data X′1 and stores therein the data X′1 as the data X′3. The second transmission method depicted in FIG. 13 is effective when the data X′1 to X′3 can be distinguished from each other and the node executing the transmission can easily be determined.

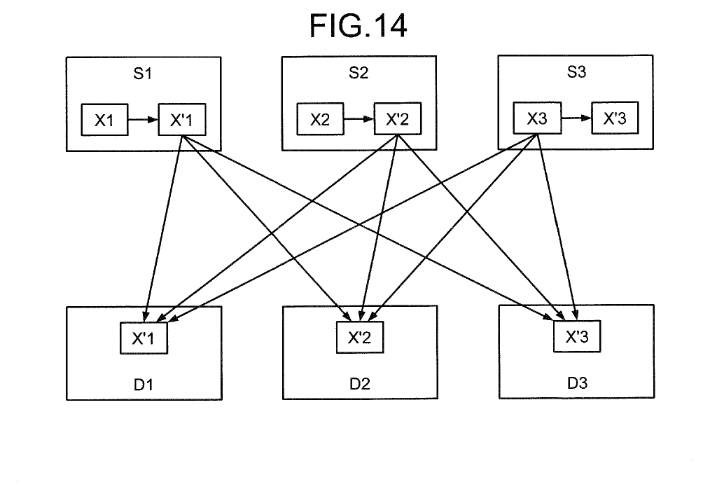

FIG. 14 is an explanatory diagram of an example of the third transmission method for the data X′. The third transmission method depicted in FIG. 14 is a method for all of the storage nodes S to transmit the data X′ to all of the transmission destination nodes D and for the transmission destination nodes D to exclude redundant data X′ and store therein the data X′.

For example, the storage node S1 transmits the data X′1 to the transmission destination nodes D1 to D3; the storage node S2 transmits the data X′2 to the transmission destination nodes D1 to D3; and the storage node S3 transmits the data X′3 to the transmission destination nodes D1 to D3. The transmission destination nodes D1 to D3 each exclude any two of the data X′1 to X′3 whose contents are same as each other, and each store therein the remaining data. The third transmission method depicted in FIG. 14 is effective when the data X′1 to X′3 can not be distinguished from each other.

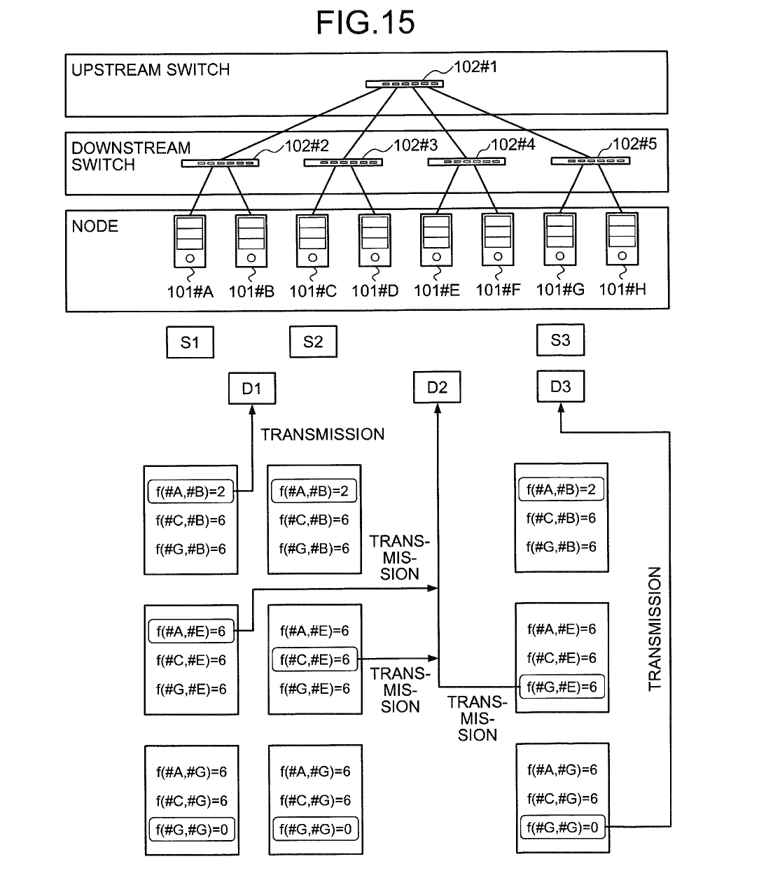

The transmission methods depicted in FIGS. 12 to 14 may each degrade the efficiency of the transmission because the storage nodes S1 to S3 do not communicate with each other in these methods. For example, it is assumed that, when the first transmission method is selected, the transmission destination nodes D1 to D3 are located at positions that are close to the storage node S1 in the network and the storage node S2 and the transmission destination node D2 are located away from each other in the network. In this case, when the storage node S2 transmits the data X′2 to the transmission destination node D2, the number of switches to relay the communication is large and therefore, this causes congestion in the network. When the nodes are located far away from each other in the network, communication is relayed by an upstream node such as the switch 102#1 and therefore, this upstream node may be a bottleneck. An example will be described with reference to FIG. 15 where a method is executed according to which the storage nodes S1 to S3 do not communicate with each other and a storage node S closely located to the transmission destination node D in the network transmits the data X′ to the transmission destination node D.

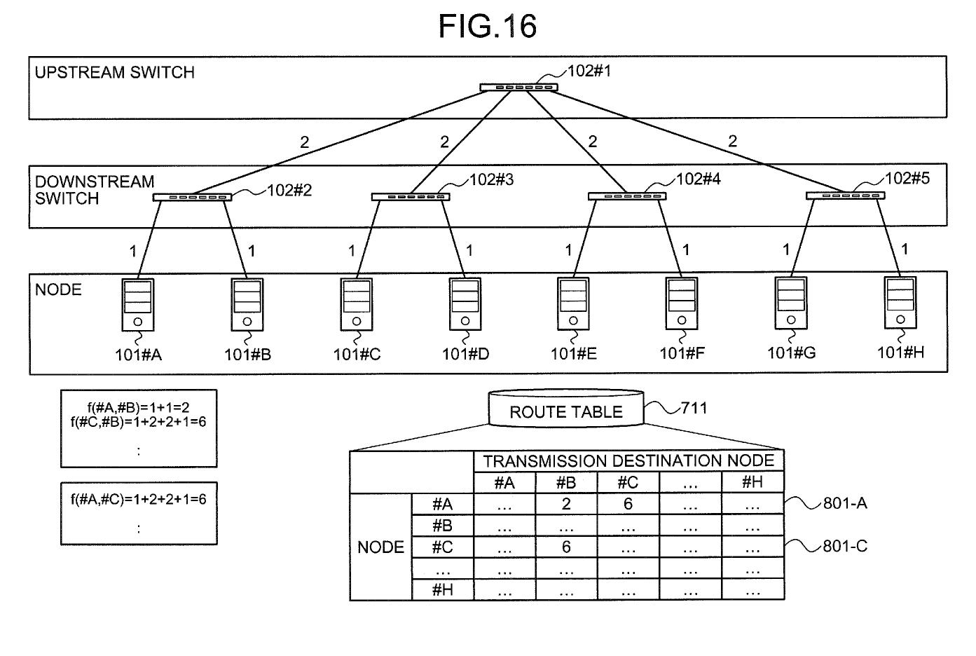

FIG. 15 is an explanatory diagram of an example of transmission determination for the data X′. FIG. 15 depicts a method of determining whether the storage nodes S1 to S3 transmit to the transmission destination nodes D1 to D3. The storage nodes S1 to S3 each determine for each of the transmission destination nodes D whether the storage node needs to transmit the data X′, using a route effect level function f(x, y) that represents the cost of the route from a node x to a node y. Specific examples of the route effect level function f will be described with reference to FIGS. 16 to 20. The route effect level function f described in the example of FIG. 15 is the specific example depicted in FIG. 16 and is a function that returns the total of the costs of the links of the nodes 101 and the switches 102.

For example, the node 101#A to be the storage node S1 calculates for the transmission destination node D1 the effect levels that are f(the storage node S1=#A, the transmission destination node D1=#B); f(the storage node S2=#C, #B); and f(the storage node S3=#G, #B). The result of the calculation is as follows.
f(#A, #B)=2
f(#C, #B)=6
f(#G, #B)=6

The node 101#A determines whether the node 101#A is the storage node whose effect level is the lowest among a group of calculated effect levels. In this case, the lowest effect level=f(#A, #B)=2 and therefore, the node 101#A determines that the node 101#A is the transmission source node that transmit the data X′ to the transmission destination node D. Therefore, the node 101#A transmits the data X′1 to the node 101#B and calculates the effect level for the node 101#E to be the transmission destination node D2. The result of the calculation is as follows.
f(#A, #E)=6
f(#C, #E)=6
f(#G, #E)=6

The node 101#A determines whether the node 101#A is the storage node whose effect level is the lowest among a group of calculated effect levels. In this case, the lowest effect level=f(#A, #E)=6 and therefore, the node 101#A determines that the node 101#A is the transmission source node that transmit the data X′ to the transmission destination node D. Therefore, the node 101#A transmits the data X′1 to the node 101#E and calculates the effect level for the node 101#G to be the transmission destination node D3. The result of the calculation is as follows.
f(#A, #G)=6
f(#C, #G)=6
f(#G, #G)=0

The node 101#A determines whether the node 101#A is the storage node whose effect level is the lowest among a group of calculated effect levels. In this case, the lowest effect level=f(#G, #G)=0 and therefore, the node 101#A determines that the node 101#A is not the transmission source node that transmit the data X′ to the transmission destination node D. Therefore, the node 101#A does not transmit the data X′1 to the node 101#G.

Similarly, the node 101#C to be the storage node S2 and the node 101#G to be the storage node S3 also respectively determine for each of the transmission destination nodes D, whether the nodes 101#C and 101#G need to transmit the data X′. Upon determining that the data X′ needs to be the transmission destination node D, the node(s) 101#C and 101#G transmits the data X′ accordingly. For example, the node 101#C transmits the data X′2 to the node 101#E and the node 101#G transmits the data X′3 to the nodes 101#E and 101#G. The node 101#G transmits the data X′3 to the node 101#G. When it is determined that the node 101 transmits the data X′ to the node 101, the node 101 may set the address of the node 101 as the transmission destination address; may set a loopback address; or may not actually transmit the data X′ and may duplicate the data X′ from the storage area storing the data X′ to the storage area to store therein the data X′. With the above processes, the storage node S can transmit the data X to the transmission destination node D that is close to the storage node S in the network without any communication among the storage nodes S1 to S3.

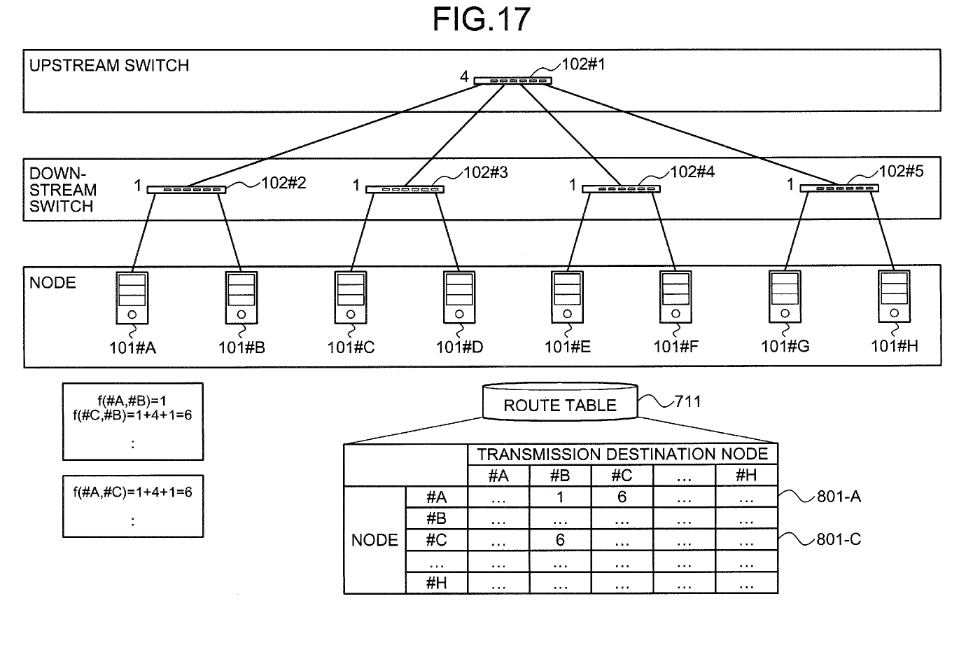

The node 101#E already receives the data X′1 to X′3. In this case, using the third transmission method depicted in FIG. 14, the node 101#E may exclude any two of the data X′1 to X′3 and may retain the remaining one. The data X′ may be prevented from being transmitted from two or more storage nodes S as much as possible. To prevent the data X′ from being transmitted from two or more storage nodes S, when plural lowest effect levels are present, effect levels may be calculated based on another criterion and the lower effect level calculated based on the other criterion may be taken as the lowest effect level. As a specific example, the effect levels used in FIG. 15 are calculated using a first example described later with reference to FIG. 16. When plural lowest effect levels are present, the storage nodes S1 to S3 may calculate the lowest effect level using the second example described later with reference to FIG. 17. A specific example of the route effect level function f will be described with reference to FIGS. 16 to 20.

FIG. 16 is an explanatory diagram of a first specific example of the route effect level function f. The route effect level function f(x, y) depicted in FIG. 16 is a function that returns the sum of the costs on the route from a node x to a node y. For example, a cost of a link between the node 101 and a downstream switch is defined as one and a cost of a link between a downstream switch and the upstream switch is defined as two. For example, the route effect level functions f depicted in FIG. 16 are f(#A, #B)=1+1=2, f(#C, #B)=1+2+2+1=6, f(#A, #C)=1+2+2+1=6, etc. The acquired effect levels are stored to respective records in the route table 711. For example: f(#A, #B)=2 is stored in the node-101#B field of the record 801-A; f(#C, #B)=6 is stored in the node-101#B field of the record 801-C; and f(#A, #C)=6 is stored in the node-101#C field of the record 801-A.

The manager of the distributed processing system 100 may identify the route from the storage node to the transmission destination node or the storage node may execute a command to identify the route from the storage node to the transmission destination node, as the identification method for the route.

The command to identify the route can be, for example, a trace route command when the switch 102 is a router. For example, the nodes 101#A to 101#H preliminarily store therein the IP address of the upstream switch. When the node 101#A executes a trace route command for a route therefrom to the node 101#B, the node 101#A can acquire a list of the IP addresses of the switches 102 present between the nodes 101#A and 101#B. The node 101#A calculates the sum of the costs of the communication to the node 101#B using the list of the IP addresses. For example, the node 101#A calculates the sum of the costs assuming that each of the cost from the node 101 to a downstream switch, the cost between downstream switches, and the cost from a downstream switch to the node 101 is one, and the cost for a link including the upstream switch is two. The result of the calculation is stored to the corresponding record in the route table 711.

The node 101#A calculates the cost of the communication between the nodes 101#A and 101#A; the cost of the communication between the nodes 101#A and 101#C; . . . ; and the cost of the communication between the nodes 101#A and 101#H. After this calculation, the node 101#A distributes the costs of the communication between the node 101#A and the nodes 101, to the nodes 101#B to 101#H. The nodes 101#B to 101#H receive the distributed costs and each store the distributed cost content to a record that corresponds to the receiving node in the route table 711. Similarly, each of the nodes 101#B to 101#H also calculates the effect level and distributes the calculated effect level to the other nodes. Thereby, the nodes 101#A to 101#H can acquire the effect levels even when any of the nodes 101 operate as the storage node and the transmission destination node.

FIG. 17 is an explanatory diagram of a second specific example of the route effect level function f. The route effect level function f(x, y) depicted in FIG. 17 is a function that returns the number of switches passed through for a route from the node x to the node y. In this case, switches that each tends to impose a high load and low-performance switches may each be counted as plural switches. For example, it is assumed that the switch 102#1 is counted as four switches. In this case, f(#A, #B)=1, f(#C, #B)=1+4+1=6, f(#A, #C)=1+4+1=6, etc.

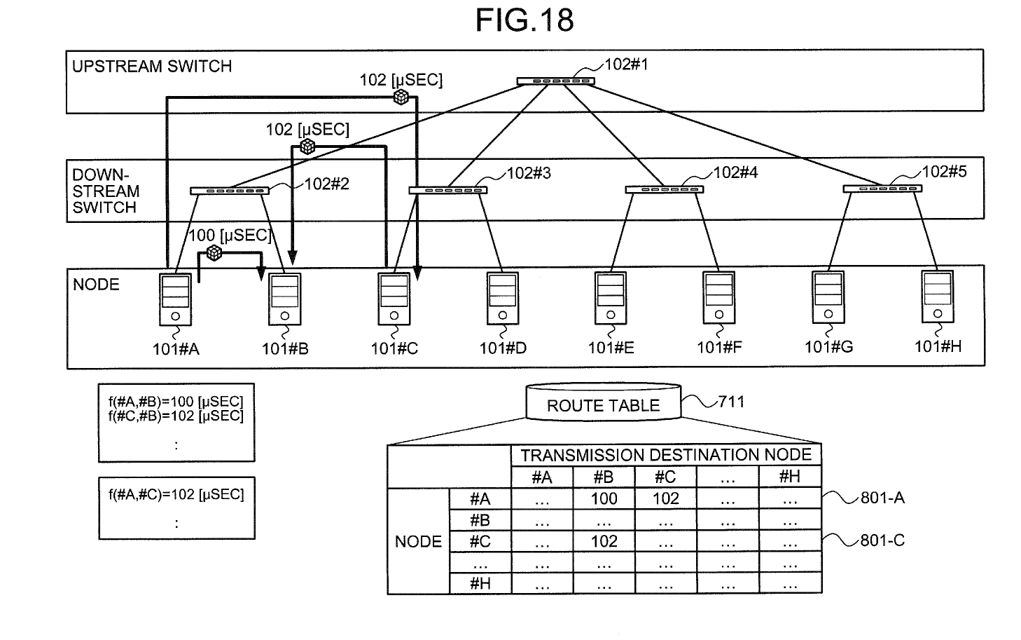

FIG. 18 is an explanatory diagram of the third specific example of the route effect level function f. The route effect level function f(x, y) depicted in FIG. 18 is a function that returns the time period taken when the data is transmitted for the route from the node x to the node y. For example, the node x transmits the data of 16 bytes to the node y and stores the time period necessary for the transmission in the record that corresponds to the node x in the route table 711. The node x may actually transmit the data or may calculate a theoretical transmission time period from a theoretical transmission speed of the route from the node x to the node y. All the nodes 101 each distribute the transmission time period taken for the data transmitted from the node to each of the other nodes, to the other nodes, and each of all the nodes 101 has the same information stored in the route table 711. The timing for the distribution may be such that all the nodes 101 distribute the information once at the start of the operation of the distributed processing system 100 or may regularly distribute the information.

For example, it is assumed that the transmission time period of the 16-byte data from the node 101#A to the node 101#B is 100 [microseconds] and that of the 16-byte data from the node 101#A to the node 101#C is 102 [microseconds]. In this case, the route effect level functions f depicted in FIG. 18 are f(#A, #B)=100 [microseconds] and f(#A, #C)=102 [microseconds]. The acquired effect level is stored to the corresponding record in the route table 711. For example, “f(#A, #B)=100” is stored in the node-101#B field of the record 801-A and “f(#A, #C)=102” is stored in the node-101#C field of the record 801-A. The node 101#A receives “f(#C, #B)=102 [microseconds]” from the node 101#C. “f(#C, #B)” is stored in the node-101#B field of the record 801-C.

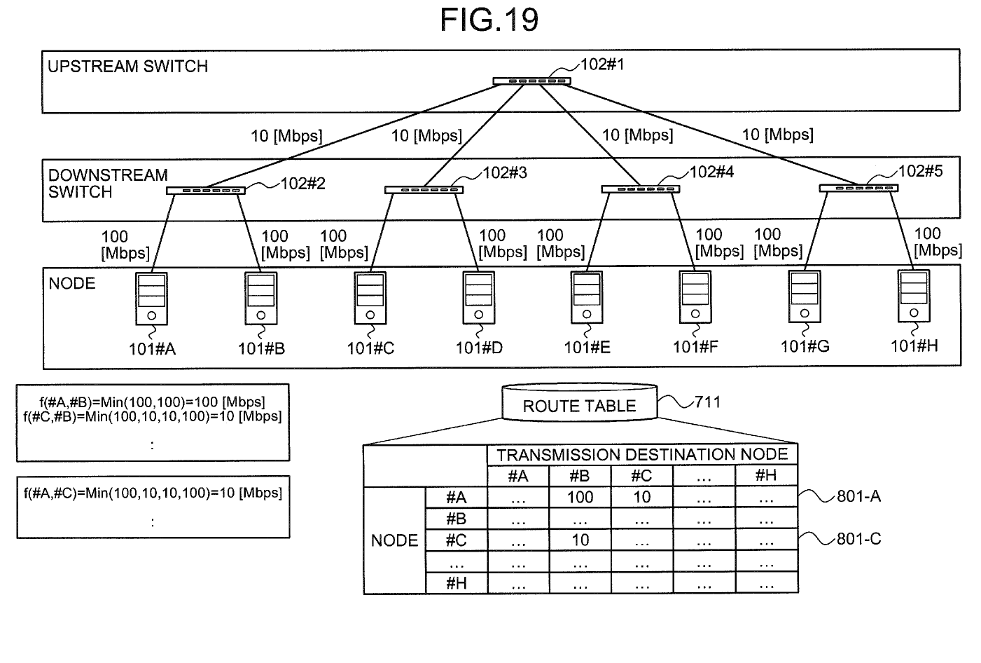

FIG. 19 is an explanatory diagram of the fourth specific example of the route effect level function f. The route effect level function f(x, y) depicted in FIG. 19 is a function that returns the bandwidth of a route from the node x to the node y. For example, f(x, y) is a function that returns the narrowest bandwidth of the bandwidths on the route.

For example, it is assumed that, on the route from the node 101#A to the node 101#B, the bandwidth between a node 101 and a downstream switch is 100 [Mbps] and the bandwidth between a downstream switch and the upstream switch is 10 [Mbps]. In this case, the route effect level functions f depicted in FIG. 19 are f(#A, #B)=Min(100, 100)=100 [Mbps], f(#C, #B)=Min(100, 10, 10, 100)=10 [Mbps], f(#A, #C)=Min(100, 10, 10, 100)=10 [Mbps], etc., where Min( ) is a function that returns the minimal value of the arguments. The acquired effect level is stored to the corresponding record in the route table 711.

The distributed processing system 100 may set the definition of the bandwidth to be a value actually measured in a state where the distributed processing system 100 is under a specific condition. The specific condition is, for example, a state where a high load is applied to each of the nodes 101. When the data amount that the node 101#A can transmit to the node 101#B per unit time is 112 [Mbits] under the specific condition, the node 101#A sets the f(#A, #B) to be f(#A, #B)=112 [Mbps]. Similarly, the node 101#A also transmits the data to each of the nodes 101#C to 101#H and sets the bandwidth. After this setting, the node 101#A distributes the set bandwidth to the nodes 101#B to 101#H. Similarly, each of the nodes 101#B to 101#H also defines the bandwidth for the other nodes and distributes the defined bandwidth to the other nodes.

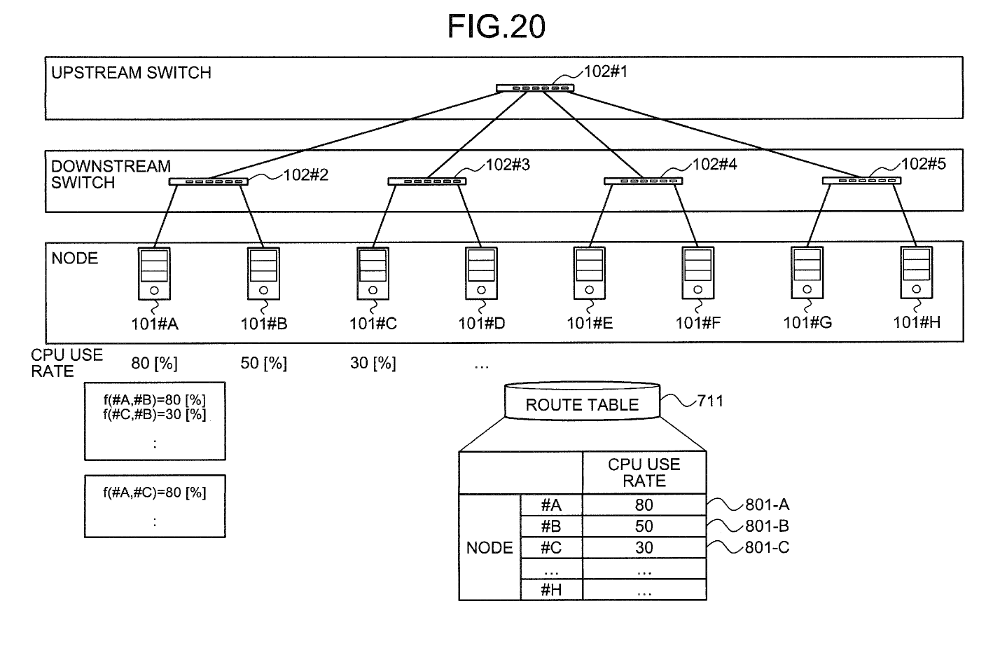

FIG. 20 is an explanatory diagram of the fifth specific example of the route effect level function f. The route effect level function f(x, y) depicted in FIG. 20 is a function that returns the CPU use rate of the node x. For example, it is assumed that, at a time point, the CPU use rate of the node 101#A is 80[%]; the CPU use rate of the node 101#B is 50[%]; and the CPU use rate of the node 101#C is 30[%]. In this case, the route effect level functions f depicted in FIG. 20 are f(#A, #B)=80[%], f(#C, #B)=30[%], f(#A, #C)=80[%], etc. The CPU use rates of the nodes 101 are distributed to all the nodes 101. The timing for this distribution may be such that all the nodes 101 may distribute the values acquired in advance by experimental measurement, at the start of the operation of the distributed processing system 100 or may distribute the values regularly measured.

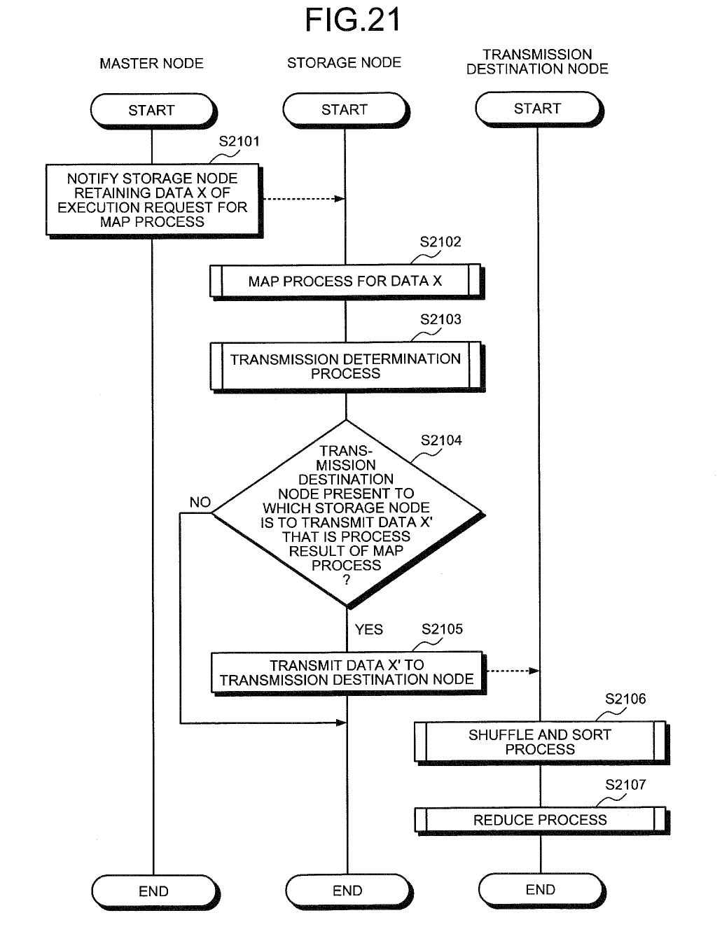

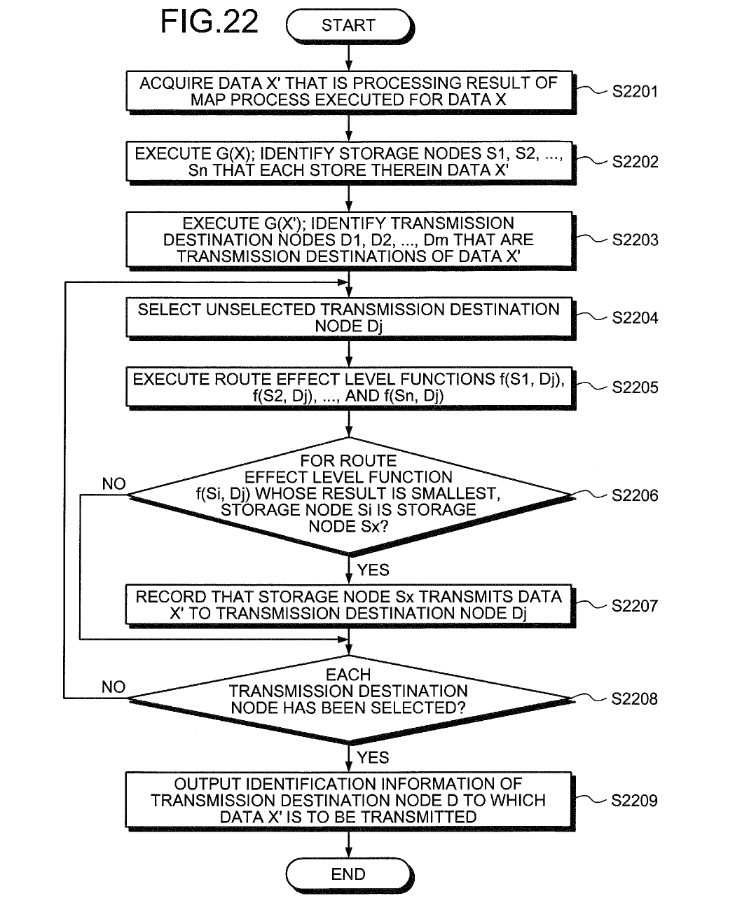

The result of the route effect level functions f(x, y) depicted in FIG. 20 depends on the node x and does not depend on the node y. Therefore, the route table 711 does not need to store any effect level for the communication between the storage node and the transmission destination node, and only has to store the effect level for the storage node. Therefore, the route table 711 may be in a storage form of, for example, that depicted in FIG. 20. The route table 711 depicted in FIG. 20 is a table that stores for each of the nodes 101, the CPU use rate of the corresponding node. For example, the CPU use rate of the node 101#A of 80[%] is stored in the record 801-A; the CPU use rate of the node 101#B of 50[%] is stored in the record 801-B; and the CPU use rate of the node 101#C of 30 [%] is stored in the record 801-C. Flowcharts executed by the distribution process system 100 will be described with reference to FIGS. 21 and 22.

FIG. 21 is the flowchart of an example of a procedure for the MapReduce process. The MapReduce process is a process of executing the distributed processing using the plural nodes 101. The master node 401 notifies the storage node retaining the data X of an execution request for the map process (step S2101). The master node 401 refers to the meta data table 414 and thereby, the master node 401 can identify which one of the nodes 101#A to 101#H is the storage node retaining the data X. The node 101 retaining the data X is the storage node. The master node 401 notifies all of the storage nodes each retaining the data X of the execution request.

The storage node receives the execution request and executes the map process for the data X (step S2102). The storage node executes a transmission determination process (step S2103). The details of the transmission determination process will be described later with reference to FIG. 22. The storage node determines whether any transmission destination node is present to which the storage node is supposed to transmit the data X′ that is the process result of the map process (step S2104). The storage node refers to the output result of the transmission determination process and thereby, can determine whether any transmission destination node is present to which the storage node is supposed to transmit the data X′.

If the storage node determines that a transmission destination node is present to which the storage node is supposed to transmit the data X′ (step S2104: YES), the storage node transmits the data X′ to the transmission destination node (step S2105). Plural transmission destination nodes may be present. After this transmission, the storage node causes the MapReduce process to come to an end. If the storage node determines that no transmission destination node is present to which the storage node is supposed to transmit the data X′ (step S2104: NO), the storage node causes the MapReduce process to come to an end.

The transmission destination node receives the data X′, executes the shuffle and sort process (step S2106), and executes the reduce process (step S2107). After the operation at step S2107 comes to an end, the transmission destination node causes the MapReduce process to come to an end. The execution of the MapReduce process enables the distributed processing system 100 to distribute jobs to the nodes 101 for processing.

FIG. 22 is the flowchart of an example of a procedure for the transmission determination process. The transmission determining process is a process for a storage node Sx to determine whether the storage node Sx transmits the data X′ to the transmission destination node. The transmission determination process is executed by each of all the storage nodes that receive the execution request for the map process in the process executed at step S2101 of FIG. 21.

The storage node Sx acquires the data X′ that is the processing result of the map process executed for the data X (step S2201). The storage node Sx executes g(X) to execute the consistent hashing for the data X; identifies the storage nodes S1, S2, . . . , Sn that each store therein the data X′ (step S2202); executes g(X′) to execute the consistent hashing for the data X′; and identifies the transmission destination nodes D1, D2, . . . , Dm that are the transmission destinations of the data X′ (step S2203). “n” and “m” are natural numbers.

The storage node Sx selects an unselected transmission destination node Dj (step S2204). “j” is an integer from one to m. The storage node Sx executes the route effect level functions f(S1, Dj), f(S2, Dj), . . . , and f(Sn, Dj) (step S2205) and determines for the route effect level function f(Si, Dj) whose result is the smallest, whether the storage node Si is the storage node Sx (step S2206).

For steps S2205 and S2206, the storage node Sx may first execute f(Sx, Dj) and then, f(Si, Dj) and may determine whether f(Sx, Dj) is larger than f(S1, Dj) by comparing these with each other. If the storage node Sx determines that f(Sx, Dj) is larger than f(S1, Dj), no possibility is present that the storage node Sx transmits the data to the transmission destination node Dj and therefore, the next transmission destination node may be selected by taking the route of “step S2208: NO”. Thereby, the case may occur where not all of f(S1, Dj) to f(Sn, Dj) need to be executed. Therefore, the storage node Sx can reduce the processing time period.

If the storage node Sx determines that the storage node Si is the storage node Sx (step S2206: YES), the storage node Sx records that the storage node Sx transmits the data X′ to the transmission destination node Dj (step S2207). After the execution of the process at step S2207 comes to an end or if the storage node Sx determines that the storage node Si is not the storage node Sx (step S2206: NO), the storage node Sx determines whether the storage node Sx has selected each of the transmission destination nodes (step S2208).

If the storage node Sx determines that an unselected transmission destination node is still present (step S2208: NO), the storage node Sx proceeds to the process at step S2204. If the storage node Sx determines that the storage node Sx has selected each of the transmission destination nodes (step S2208: YES), the storage node Sx outputs identification information of the transmission destination node D to which the storage node Sx is supposed to transmit the data X′ (step S2209). After the process at step S2209 comes to an end, the storage node Sx causes the transmission determination process to come to an end. By executing the transmission determination process, a node 101 can determine whether the transmission source node is the node 101 without any communication among the nodes 101.

As described, with the node 101 according to the embodiment, each of the nodes 101 having the same data determines based on the same criterion whether the load necessary for the communication between the node 101 and the transmission destination node is lower than the loads for the other nodes 101 and if the node 101 determines that the load is lower than the loads for the other nodes 101, the node 101 operates as the transmission source node. Thereby, the distributed processing system 100 can transmit the data using a route whose load on the distributed processing system 100 is low even when the transmission destination node is not determined by any communication among the nodes 101.

According to the node 101, the master node 401 does not have to concentrate on determining the transmission source node and the load on the nodes 101 can be dispersed among the nodes 101. The communication is executed from the server whose route cost to the node to be the re-disposition destination of the data is the lowest among the servers that each retains a replica of the original data and consequently, the passing of the communication through any high-cost route can be suppressed. According to the node 101, concentration of communication on any specific route can be prevented and the specific route can be prevented from being a bottleneck. According to the node 101, the throughput can be improved; thereby, the time period necessary for the data transfer can be reduced; and an increase of the speed, a reduction of the cost, and a reduction of the load can be realized.

According to the node 101, the data may be transmitted when the effect level for the communication between the node 101 and the transmission destination node is lower than the effect level for the communication between another node and the transmission destination node. Thereby, the distributed processing system 100 can determine using one comparison whether the node 101 has to transmit the data and therefore, can determine at a high speed whether the node 101 has to transmit the data.

According to the node 101, a comparison may be executed between the lowest value of the effect levels for the communication between the plural other nodes and the transmission destination node, and the effect level for the communication between the node 101 and the transmission destination node. Thereby, in the distributed processing system 100, the node whose load is the lowest on the distributed processing system 100 can transmit the data even when the transmission source is not determined by any communication among the nodes 101.

According to the node 101, other nodes can be identified among the plural nodes 101 based on the data. Thereby, the node 101 can identify another node without inquiring to the master node 401, etc., and therefore, communication for identifying the other node can be reduced.

According to the node 101, the effect level may be calculated for the communication between the node 101 and the transmission destination node based on the number of switches that relay the communication between the node 101 and the transmission destination node. Thereby, the distributed processing system 100 can transmit the data using the route that includes a small number of relaying switches and whose load is low on the distributed processing system 100.

According to the node 101, the effect level may be calculated for the communication between the node 101 and the transmission destination node based on the bandwidth of the communication between the node 101 and the transmission destination node. Thereby, the distributed processing system 100 can transmit the data using the communication route whose bandwidth is wide and in which congestion does not tend to occur.

According to the node 101, the effect level may be calculated for the communication between the node 101 and the transmission destination node based on the use rate of the processor or the memory of the node 101. Thereby, in the distributed processing system 100, the data can be transmitted using the node whose processing performance has room for the transmission and therefore, any delay can be prevented of the data transmission process due to a high load of the node.

Although the distributed processing system 100 according to the embodiment employs “Hadoop”, configuration is not limited to Hadoop and the transmission control method according to the embodiment can be applied when redundant data is present at each of plural nodes and the plural nodes transmit the data to the transmission destination node.

The transmission method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to an aspect of the present invention, an effect is achieved that the load on the system can be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a transmission control program that causes a first node to execute a process comprising:
identifying among nodes included in a system, a second node that stores therein data that is identical to data stored in the first node;
comparing a first effect level representing a degree to which performance of the system is affected by communication between the first node and a transmission destination node that is a transmission destination of the data among the nodes, and a second effect level representing a degree to which the performance of the system is affected by communication between the identified second node and the transmission destination node, by referring to a storage device that stores effect levels respectively representing a degree to which the performance of the system is affected by communication between the transmission destination node and each node among the nodes; and
transmitting based on a result obtained at the comparing, the data to the transmission destination node by controlling a communicating unit that communicates with the nodes.

2. The computer-readable recording medium according to claim 1, wherein
the transmitting includes transmitting the data to the transmission destination node by controlling the communicating unit, when the first effect level is lower than the second effect level.

3. The computer-readable recording medium according to claim 2, wherein
the comparing, when plural second nodes are identified, includes comparing the first effect level and a lowest effect level among effect levels respectively representing a degree to which the performance of the system is affected by communication between the transmission destination node and each of the identified second nodes.

4. The computer-readable recording medium according to claim 1, wherein
the identifying includes identifying the second node from among the nodes based on the data.

5. The computer-readable recording medium according to claim 1, the process further comprising:
calculating the first effect level based on the number of switching apparatuses that relay the communication between the first node and the transmission destination node; and
calculating the second effect level based on the number of switching apparatuses that relay the communication between the second node and the transmission destination node, wherein
the comparing includes comparing the calculated first effect level and the calculated second effect level.

6. The computer-readable recording medium according to claim 1, the process further comprising:
calculating the first effect level based on bandwidth of the communication between the first node and the transmission destination node; and
calculating the second effect level based on bandwidth of the communication between the second node and the transmission destination node, wherein
the comparing includes comparing the calculated first effect level and the calculated second effect level.

7. The computer-readable recording medium according to claim 1, the process further comprising:
calculating the first effect level based on a use rate of a processor or a memory of the first node; and
calculating the second effect level based on a use rate of a processor or a memory of the second node, wherein
the comparing includes comparing the first calculated effect level and the calculated second effect level.

8. A communication node comprising:
an identifying unit that among nodes included in a system, identifies a second node that stores therein data whose content is identical to that of data stored in a first node;
a comparing unit that compares a first effect level representing a degree to which performance of the system is affected by communication between the first node and a transmission destination node that is a transmission destination of the data among the nodes, and a second effect level representing a degree to which the performance of the system is affected by communication between the identified second node and the transmission destination node, by referring to a storage device that stores effect levels respectively representing a degree to which the performance of the system is affected by communication between the transmission destination node and each node among the nodes; and
a communicating unit that based on a result obtained at the comparing, transmits the data to the transmission destination node.

9. A transmission control method executed by a first node, the transmission control method comprising:
identifying among nodes included in a system, a second node that stores therein data that is identical to data stored in the first node;
comparing a first effect level representing a degree to which performance of the system is affected by communication between the first node and a transmission destination node that is a transmission destination of the data among the nodes, and a second effect level representing a degree to which the performance of the system is affected by communication between the identified second node and the transmission destination node, by referring to a storage device that stores effect levels respectively representing a degree to which the performance of the system is affected by communication between the transmission destination node and each node among the nodes; and
transmitting based on a result obtained at the comparing, the data to the transmission destination node by controlling a communicating unit that communicates with the nodes.
